(19) United States
(12) Patent Application Publication
(10) Pub. No.: US 2023/0284641 A1
(43) Pub. Date: Sep. 14, 2023

(54) ISOCHORIC IMPREGNATION OF SOLID FOODS AT SUBFREEZING TEMPERATURES

(71) Applicants: The United States of America, as represented by the Secretary of Agriculture, Washington, DC (US); UNIVERSITY OF CALIFORNIA AT BERKELEY, Berkeley, CA (US)

(72) Inventors: TARA H. MCHUGH, ALBANY, CA (US); CRISTINA BILBAO-SAINZ, ALBANY, CA (US); MATTHEW J. POWELL-PALM, BOZEMAN, MT (US); BORIS RUBINSKY, EL CERRITO, CA (US)

(21) Appl. No.: 17/692,784

(22) Filed: Mar. 11, 2022

(51) Int. Cl. A23B 7/10; A23B 7/055; A23B 7/154; A23L 19/00; A23L 33/15

(52) U.S. Cl. CPC A23B 7/10; A23B 7/055; A23B 7/154; A23L 19/03; A23L 33/15; A23V 2002/00

(57) ABSTRACT

Fruits and vegetables are impregnated with ascorbic acid impregnation fluids during an isochoric freezing process. The ascorbic acid impregnation fluids are infused into the void pores of fruits and vegetables, without destroying cellular tissue. The infusion of ascorbic acid can prevent browning of fruits and vegetable products, increase the products' vitamin C content, and inhibit microbial growth.

### REFERENCE TO RELATED APPLICATIONS

This application claims the benefit of U.S. Provisional Application No. 63/159,528, filed Mar. 11, 2021, which is incorporated herein by reference in its entirety.

### FIELD OF THE INVENTION

The disclosed subject matter relates to the isochoric freezing process. The subject matter described herein relates to a system and method for impregnating a targeted solid food item with impregnation fluids during the isochoric freezing process. The impregnation fluids are selected to enhance the quality of the targeted food item. Specifically, the isochoric freezing process is used to impregnate a fruit or vegetable with an ascorbic acid impregnation solution. The ascorbic acid impregnation solution is infused into the void pores of fruits and vegetables, without destroying cellular tissue. The infusion of ascorbic acid can prevent browning of the cut fruit and vegetable products and increase their vitamin C content. Ascorbic acid may also preserve the color of an infused fruit or vegetable product and inhibit microbial growth.

### BACKGROUND OF THE INVENTION

One of the most common and well-established food preservation techniques is freezing. Freezing lowers the rate of deterioration in food quality over time by reducing microbial and enzymatic activities, oxidation and respiration, and thereby extending food storage life. However, freezing frequently leads to intercellular damage in the affected food product. Cell damage in biological tissues causes irreversible turgor loss, loss of firmness, loss of water holding capacity, and it increases drip loss during thawing. The cellular damage may also affect the taste and texture of the frozen food.

To address this problem, the inventors explored isochoric freezing systems that minimize cellular damage while successfully preserving food products. The inventors specifically investigated isochoric infusion as a means of preserving fruits and vegetables. During the isochoric freezing process, a food product is immersed in a solution in osmotic equilibrium with the food product and processed inside a fixed-volume, high-pressure isochoric chamber. When the temperature of the isochoric chamber is decreased to a point where freezing occurs, ice forms and expands in a designated area of the chamber—causing an increase in chamber pressure. As ice continues to form, the pressure inside the isochoric chamber continues to increase until a thermodynamic equilibrium exists between ice and water in the chamber at a predetermined pressure and temperature. The isochoric chamber is structured so that the ice forms in an area of the chamber that is in communication with (but separate from) the food product storage area. This separation enables the food product to be stored at subfreezing temperatures without suffering the physical cellular damage caused by the freezing process and the intercellular formation of ice.

While analyzing the isochoric freezing process, the inventors noted that fluids present in the area around a targeted food product are infused into the intercellular spaces of the food product. The inventors discovered that by prudently selecting the fluid impregnating the food product (i.e. the “impregnation fluid”), the characteristics of the food product could be enhanced.

Based on this insight, the inventors specifically investigated using an ascorbic acid impregnation fluid to enhance the quality of a variety of fruits and vegetables products. The inventors determined that isochoric impregnation is a fast, controlled, and uniform way of infusing an ascorbic acid impregnation fluid 24 into fruits and vegetables 20 without destroying the original structure of the food product 20. The ascorbic acid impregnation fluid 24 is retained in the biological tissues of the fruit and vegetable product 20 since the compounds are trapped in the pores of the food product.

### SUMMARY OF THE INVENTION

This disclosure is directed to a method of infusing an ascorbic acid impregnation fluid into a fruit and/or vegetable food item. In operation, a user places the ascorbic acid impregnation fluid into a flexible food container. The fruit or vegetable item is then added to the food container so that the ascorbic acid impregnation fluid is in fluid contact with the fruit or vegetable food item. The food container is then closed and placed in an isochoric freezing chamber that is filled with a water solution. Once the isochoric chamber is closed, the temperature of the isochoric chamber is reduced to at least 0° C. so that ice forms in the isochoric chamber. As the pressure in the isochoric chamber increases, the ascorbic acid impregnation fluid penetrates the intercellular structure of the fruit and vegetable product and thereby infuses the food product with the ascorbic acid impregnation fluid.

### BRIEF DESCRIPTION OF THE DRAWINGS

The patent or application file associated with this disclosure contains at least one drawing executed in color. Copies of this patent or patent application publication with color drawing(s) will be provided by the Office upon request and payment of the necessary fee.

FIG. 1 is a sectional schematic view of the isochoric system.

FIG. 2 is a panel photograph of potato cubes. FIG. 2 Sample A is a fresh potato cube. FIG. 2 Samples B and C are potato cubes that have been subjected to isochoric freezing under various conditions.

FIG. 3 is graphical representation of pressure as a function of time during the isochoric impregnation experiments.

FIG. 4a. is a photograph of Granny Smith apples infused with 4% ascorbic acid sucrose solution.

FIG. 4b. is a photograph of Beauregard Sweet potatoes infused with 4% ascorbic acid sucrose solution. Different impregnation methodologies are used for FIGS. 4a. and 4b.

FIG. 5 is Cryo-SEM images of: (5a) parenchyma tissue of fresh apple; (5b) parenchyma tissue of apple impregnated at −3° C. for 5 hours; (5c) parenchyma tissue of apple impregnated at −5° C. for 5 hours; (5d) perimedullar tissue of fresh sweet potato; (5e) perimedullar tissue of sweet potato impregnated at −3° C. for 5 hours; and, (5f) perimedullar tissue of sweet potato impregnated at −5° C. for 5 hours.

FIG. 6 is photographs displaying 6a fresh cherry and cherries preserved for 30 days using different techniques: 6b Refrigeration at 3° C./90% RH; 6c Isochoric cold storage at −5° C./15 MPa with sucrose/ascorbic acid impregnation; 6d Isochoric cold storage at −5° C./15 MPa of vacuum-packed cherries; 6e Isobaric cold storage at −5° C./0.1 MPa of cherries immersed in sucrose/ascorbic acid solution; and, 6f Isobaric cold storage at −5° C./0.1 MPa of vacuum-packed cherries.

FIG. 7 is Cryo-SEM images of fresh cherry 7a and cherries preserved for 30 days using different techniques: 7b Refrigeration at 3° C./90% RH; 7c Isochoric cold storage at −5° C./15 MPa with sucrose/ascorbic acid impregnation; 7d Isochoric cold storage at −5° C./15 MPa of vacuum-packed cherries; 7e Isobaric cold storage at −5° C./0.1 MPa of cherries immersed in sucrose/ascorbic acid solution; 7f Isobaric cold storage at −5° C./0.1 MPa of vacuum-packed cherries.

### DETAILED DESCRIPTION OF PREFERRED EMBODIMENTS

### System Overview

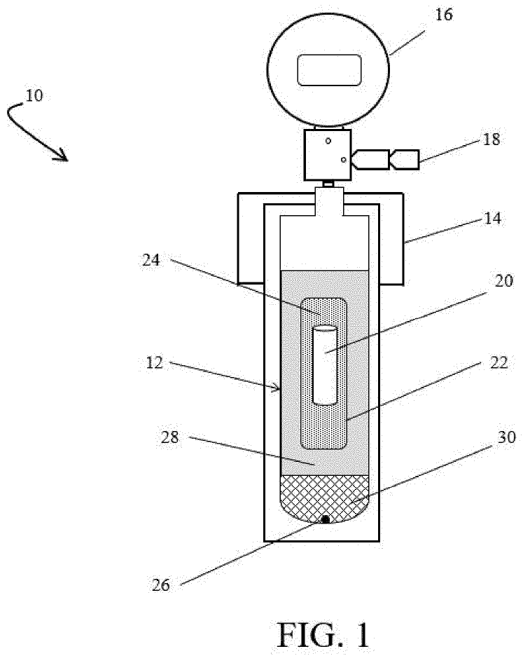

As generally shown in FIG. 1, the isochoric system 10 comprises a high-pressure isochoric chamber 12 that is enclosed with a sealing cap 14. A digital transducer 16 monitors the pressure within the chamber 12. A safety head with a rupture disk 18 is in fluid communication with the interior of the isochoric chamber 12 to ensure that the conditions inside the chamber 12 do not exceed safety standards.

In accordance with the inventor's isochoric impregnation process, as shown in FIG. 1, a selected food item (preferably a fruit or vegetable) 20 is placed in a durable but flexible and collapsible container 22. The container 22 is preferably filled with an impregnation fluid 24 and sealed. In the preferred embodiment, the impregnation fluid is an ascorbic acid impregnation fluid.

For the purposes of this disclosure, an “ascorbic acid” (also known as “ascorbate” or “Vitamin C”) is defined as bioactive substance found in various foods and sold as a dietary supplement. Ascorbic acid is a water soluble essential nutrient involved in the repair of tissue, the formation of collagen, and the enzymatic production of certain neurotransmitters. “Ascorbic acid impregnation fluid” is an impregnation fluid comprising more than a trace amount of ascorbic acid.

Ascorbic acid is a bioactive substance and isochoric impregnation is one means of creating a “functional food”. “Functional foods” are foods that have a potentially positive effect on health beyond basic nutrition. Functional foods promote optimal health and help reduce the risk of disease. A familiar example of another functional food is fortified oatmeal because it contains soluble fiber that can help lower cholesterol levels.

In the preferred embodiment, the ascorbic acid impregnation fluid 24 is in isotonic equilibrium with the selected food item 20. In alternative embodiments, the impregnation fluid 24 may also include multiple other supplemental ingredients—as required to flavor and/or preserve or otherwise enhance the quality of the selected food item 20. An ice nucleating component 26 is placed in the bottom of the chamber 12, and the chamber 12 is completely filled with an aqueous solution—preferably a water-based solution 28.

For the purposes of this disclosure, a “water-based solution” comprises a solution that is primarily water (preferably distilled water) but may contain other chemicals so that the freezing point of the water-based solution may be modified as required for a specific application. For example, the water-based solution may comprise a food-grade polyethylene glycol (95:5) solution. The food container 22 (with the enclosed food item 20 and impregnation fluid 24) is placed in the isochoric chamber 12 near the top of the chamber 12.

After the chamber 12 is prepared and loaded as described supra, the chamber 12 is cooled—preferably in a conventional cooling bath. In the preferred embodiment, the cooling bath cools the chamber 12 contents to a freezing or subfreezing temperature based on a protocol for the enclosed food item 20 and associated impregnation fluid 24. As the contents of the isochoric chamber 12 are cooled, ice 30 forms around the ice nucleating component 26 in the bottom portion of the chamber 12, and pressure builds within the chamber 12. Isochoric impregnation can be used in the range of temperatures between the freezing temperature and the triple point of the aqueous solution. If the chamber is filled with a water solution, isochoric impregnation can be performed in the temperature range of 0° C. to −22° C. At the lowest temperature of −22° C., the pressure is 210 MPa and the volume occupies by ice is 60%. The chamber is designed so that the flexible container with the selected food remains in the space occupied by the water-based solution during the impregnation process. In a preferred embodiment, the maximum pressure is 30 MPa and the volume occupied by ice is 15%.

The current inventors' contribution to the art is (among other things) the understanding that isochoric impregnation can be used to introduce an ascorbic acid impregnation fluid 24 into the void spaces of fruits and vegetables 20 without destroying the cellular tissue. Depending on the selected fruit and/or vegetable, an infusion of ascorbic acid helps prevent discoloration (e.g. “browning”) of fruits and vegetable products, inhibits microbial growth, and increases the product's vitamin C.

There are multiple advantages for using isochoric impregnation to infuse fruits and vegetables with ascorbic acid. In addition to providing thoroughness and uniformity of liquid infusion, the process of isochoric impregnation may also occur over faster timescales than conventional infusion or moisture enhancements processes. In conventional injection-based moisture enhancements, injected fluids may only spread from the point of injection by osmotic diffusion, a process that is both slow and limited to a finite penetration depth surrounding the injection point.

In isochoric impregnation however, the impregnation fluid does not travel by diffusion but instead by mechanical action driven by the elevated hydrostatic pressure in the surrounding environment of the isochoric chamber. The impregnation fluid is compelled by pressure to fill the intercellular air gaps within the pores of the fruit or vegetable, a process which may take place several orders of magnitude faster than simple osmotic diffusion, depending on the precise hydrostatic pressure employed.

Isochoric freezing is also an energy-efficient process, because the limited ice formation within the chamber requires only limited consumption of latent heat (the thermal energy required for phase transitions such as freezing). Isochoric freezing has for this reason been demonstrated to be superior to conventional freezing in terms of energy consumption during food preservation. Isochoric impregnation can thus reduce the total energy consumed during fruit and vegetable processing of moisture-enhanced, infused, or otherwise impregnated foods by combining the impregnation process with the preservation process, removing the need for two distinct processing steps.

### EXAMPLES

The inventors conducted multiple experiments that demonstrated the process and the effects of isochoric impregnation on various fruits and vegetables having a variety of textures and characteristics. Specifically, the inventors investigated white potatoes, apples, sweet potatoes, and sweet cherries. Some of the exemplary experiments are described infra.

The Experiment Group 1 Section is a summary that describes an investigation using white Russet Burbank potatoes with reference to the isochoric freezing apparatus shown in FIG. 1 and described supra. Experiment Groups 2 and 3 are more detailed and comprehensive investigations that involve multiple individual experiments. The processes described in Experiment groups 2 and 3 also use the isochoric freezing apparatus discussed supra, however the experiments are described without direct reference to FIG. 1.

### Experiment Group 1— Russet Burbank White Potatoes

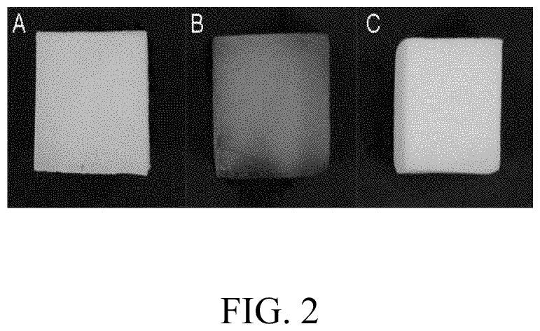

The inventors selected exemplary specimens of fresh white (variety Russet Burbank) potatoes (Solanum tuberosum) were procured from a local store. The inventors first cut the potatoes into cubes. A fresh potato cube is shown as Sample A in FIG. 2. The fresh potato cubes 20 were placed in a first food container 22, and the container 22 was vacuum-packed, sealed, and placed in a first isochoric chamber 12. The vacuum-packed potato cubes 20 were designated as Sample B.

Fresh potato cubes 20 were also placed in a second food container 22, and the food container 22 was filled with an isotonic solution of 5% (w/w) aqueous ascorbic acid solution 24 so that the potato cubes 20 were immersed in the ascorbic acid—and then the food container 22 was sealed and placed in a second isochoric chamber 12. The ascorbic acid-immersed potato cubes 20 were designated as Sample C.

The temperatures of isochoric chambers 12 of both Sample B and Sample C were lowered to −3° C. After 3 weeks in isochoric freezing storage, the Sample B vacuum-packed potato cubes 20 were removed and examined. The Sample B potato cubes 20 appeared dark due to browning—as shown in FIG. 2. Browning reactions occur when phenolic compounds are oxidized to ortho-quinones in the presence of oxygen and the polyphenol oxidase enzyme. The ortho-quinones are then rapidly polymerized to brown pigments. These samples also lost 82% of their original ascorbic acid content.

After 3 weeks the Sample C potato cubes 20 were also removed and examined. However, the Sample C potato cubes 20 that were immersed in ascorbic acid solution 24 did not exhibit browning—as shown in FIG. 2. In Sample C, enzymatic browning was inhibited by the ascorbic acid fluid 24 in which the Sample C potato cubes were immersed. Also, the ascorbic acid content of the Sample C potato cubes 20 significantly increased. The ascorbic acid content of the Sample A fresh potato cubes was about 10.9±0.3 mg per 100 g of potatoes. In comparison, the ascorbic acid content of the Sample C potatoes after isochoric storage was 1493±27 mg per 100 g of potatoes.

These results show that isochoric freezing can be used to infuse external components (such as ascorbic acid) inside the food products while preserving them at subfreezing temperatures. This impregnation occurs even in foods with low porosity, such as potatoes that have an intercellular space volume as low as 1% of the total volume.

### Experiment Group 2—Granny Smith Apples and Beauregard Sweet Potatoes.

The inventors chose sweet potatoes and apples as model foods because they have very different porosity values but similar soluble solids contents. Granny Smith apples (hybrid of Malus domestica and Malus sylvestris) and Beauregard sweet potatoes (Ipomoea batatas I. Lan,) were procured from a local supermarket and stored at 5° C. for no longer than 10 days during which experiments were performed. The apples and sweet potatoes were cut into cylindrical samples (21 mm in height and 21 mm in diameter) in the axial direction with a cork borer and razor blade. The samples were obtained from the parenchyma tissue in apples and from the vascular ring inward for sweet potatoes.

The porosity (εr) of apples and sweet potatoes was determined according to Eq. 1 using the apparent density (pa) (g/cm³) and the real density (pr) (g/cm³). The apparent density (pa) and the real density (pr) were determined by volume displacement in a pycnometer using toluene.

The tests were performed in triplicate.

$$. {ε}_{r} = 1 - \frac{{ρ}_{a}}{{ρ}_{r}} \qquad ( Eq . 1 )$$

The impregnation medium consisted of 7% sucrose and 4% ascorbic acid in distilled water. The ° Brix of the impregnation solution was 11.5±0.2. Five cylindrical samples were packaged in a moisture-impermeable plastic bag filled with the impregnation solution at a solid to liquid ratio of 1:7 (v/v). Two pouches with a total of 10 samples were used for each process time. For the control treatment, six pouches were kept in the refrigerator at 5° C. Two pouches were withdrawn after 1, 3 and 5 hours for analysis. For the isochoric impregnation treatment, 2 pouches were directly placed in the isochoric chamber filled with distilled water. The isochoric chamber was tightly closed and immersed in an insulated container connected to a recirculating cooling bath. The freezing temperature was set at −3° C. or −5° C. The samples were processed for 1, 3 or 5 hours at the selected temperature. After this, the chamber was immersed in a room temperature water bath to decrease the pressure. The processing conditions were selected based on the inventors' earlier work. The chamber was connected to an electronic pressure transducer that was connected to a laptop to monitor the pressure. The data was recorded and displayed with the Additel 9502 data logging and graphical software.

After processing, the pouch was cut open, samples were blotted gently with tissue paper and then weighed. Mass change was calculated gravimetrically and reported as the percent change in sample mass based on its initial mass. Volume change was determined using a digital caliper micrometer and reported as the percent change in sample volume based on its initial volume. Mass changes and volume changes were determined ten times for each treatment condition. The moisture content of raw potato was determined using a conventional oven at 105° C. for 72 hours. The soluble solids content (expressed as ° Brix) was determined by measuring the refractive index with a digital refractometer. Moisture and solids content were determined for 3 different samples.

A high-resolution digital camera (Nikon-7000) was used to capture color images of half sliced samples under constant lightening. A spectrophotometer (CM508D, Konica Minolta Inc., Ramsey, NJ, USA) equipped with a D65 illuminant was used for color analyses. Measurements were performed directly on the center of half sliced samples using a target mask with a measurement area of 12 mm and 10° standard observer. For each treatment, both halves of 6 cylinders were analyzed. Color data were reported as L* (black 0, white 100), a* (red-green), b* (yellow-blue) and color difference (ΔE*) with respect to the fresh samples according to equation 2, where L0*, a0* and b0* represented the readings of the fresh samples.

·ΔE*=\sqrt{(L*0−L*)²+(a*0−a*)+(b*0−b*)} (Eq. 2)

Scanning electron microscopy (SEM) was used to analyze microstructural changes after isochoric impregnation at −3° C. or −5° C. for 5 hours. One sample was chosen for each treatment. The cylinder was cut into cross-sections and the center pieces were cut into three or four samples. Each sample was placed in the SEM sample holder and plunged into subcooled nitrogen (−210° C.). The frozen sample was transferred to the cryostage and then freeze fractured and coated with platinum. The samples were viewed in a JEOL 7900F field emission scanning electron microscope using a Quorum PP3010T cryo system. Mechanical properties of fresh and impregnated samples were determined by a compression test following the procedure in Luscher et al., (2005) with minor modifications and described in Bilbao-Sainz et al. (2020). The compression test was performed with a Texture Analyzer (Stable Microsystems Ltd., TA-XT2i, UK) at 23° C. Six cylinders were tested for each treatment. The samples were compressed to 50% deformation in a single compression-decompression cycle at a speed of 0.1 mm/s using a 50-mm-diameter circular flat plate (TA-25 probe).

Ascorbic acid was extracted from the cylinders immediately after processing and thawing for 1 hr. by blending the sample tissue with the extraction solution at a ratio of 1:2.5. The extraction solution consisted of 30 g metaphosphoric acid, 0.5 g of EDTA and 80 mL of glacial acetic acid diluted to 1 L with distilled water. The blended sample was centrifuged (10,000 rpm) at 4° C. for 15 min. The collected supernatant was filtered and passed through solid-phase extraction cartridges (Bond Elut C18, 500 mg, 3 mL, Agilent Technologies) that were preconditioned with 2 mL of acetonitrile followed by 3 mL of distilled water. Ascorbic acid was analyzed by injecting 50 μL of the sample into an Agilent HPLC 1100 series liquid chromatograph (Agilent Technologies, Wilmington, Del., USA) equipped with an Agilent diode array detector. An ICSep ICE-ION-300 (300×7.8 mm) column and guard column with the same packing were used as the stationary phase. The mobile phase was 20 mM of H₂SO₄ solution at a flow rate of 0.3 mL/min. The ascorbic acid content was quantified through a standard calibration curve. Ascorbic acid contents were determined from 3 different samples for each treatment.

The results were statistically analyzed using Minitab version 19 statistical software. Significance differences between different impregnation treatments were assessed by performing two-way ANOVA and Interval plots at 95% confidence intervals. Statistically significant differences at the level of p≤0.05 are marked with different letters.

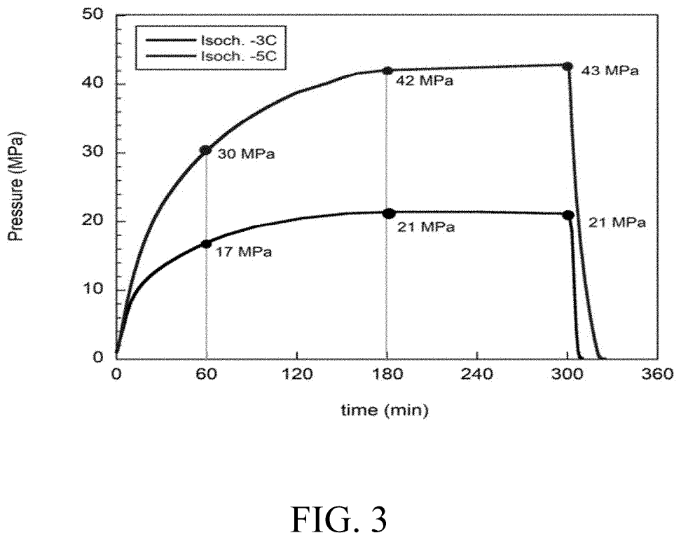

FIG. 3 displays the pressure as a function of time during isochoric impregnation at −3° C. and −5° C. During isochoric impregnation, the loaded chamber was cooled to −3° C. or −5° C. As water solidified into ice, the decrease in density gradually elevated the pressure inside the constant volume chamber. The increase in pressure during temperature decrease follows the liquidus curve in the phase diagram of water. This minimizes the pressure for each temperature during the impregnation treatment. The pressure continued to increase until a thermodynamic equilibrium was reached between the ice phase and the liquid phase at the set temperature. At this point, a constant pressure of 21 MPa at −3° C. and 43 MPa at −5° C. was reached in the chamber. At the end of the treatment, there was rapid depressurization when the chamber was warmed to room temperature and the process was terminated. Table 1 shows the total mass changes, total volume changes, water contents and soluble solids contents of the apple and sweet potato samples. The porosity of apples was 25.6±2.1%, which was similar to the porosity values reported in literature for Granny Smith apples. The control immersed apple sample showed a gradual increase in mass with time due to the infusion of the external solution into the apples by capillary action. In comparison, the isochoric impregnated apples showed a greater mass increase than the control samples due to the increase in mass transfer rates during pressure-induced impregnation. The mass transfer in the samples was due to osmosis, diffusion and hydrodynamic mechanisms. The impregnation temperature/pressure affected total mass changes in the samples. A gradual increase in mass occurred with time at −3° C. (i.e. lower pressure applied). In comparison, mass gain was highest after 3 hours of impregnation time at −5° C. (i e higher pressure applied). After this point, the apples lost mass, which might indicate a disruption of the parenchyma cellular tissue. The control apple sample showed a volume increase that ranged from 1.8% to 2.4%, whereas the isochoric impregnated apples showed slightly higher increases in volume that ranged from 2.4% to 4.7%. The increase in volume could be due to the increase in cell turgor and swelling of the cellular components as water penetrated and diffused inside the cellular tissue. Fresh apples had a water content of 87.33%±0.09. The control samples had a slightly higher (<1%) water content, whereas isochoric impregnated samples had an average of 2.1% increase in water content. This was due to the concentration gradient, which favored mass transfer of water from the liquid medium to the product. The soluble solids content for fresh apples was 12.8±0.6 g/100 g. No significant differences (P>0.05) in the soluble solids content were found between fresh and treated apples.

The porosity of sweet potatoes was 9.6±2.6%, which was between the 15% porosity value reported by Lozano, Rotstein and Urbicain (1983), and the 4.3±2.1% porosity value reported by Monteiro et al., (2020). Sweet potatoes have very small intercellular spaces, but the potato tissue contains a vascular ring, numerous strands of embedded vascular tissue in the perimedullar storage parenchyma and large vascular strands in the inner medulla that could also contribute to the overall porosity value.

The control immersed potato samples showed a gradual mass increase from 0.5% after 1 hour to 1.6% after 5 hours due to capillary action. In comparison, isochoric impregnated samples gained an average of 9.3% mass. During isochoric impregnation, the gas phase present in the intercellular spaces and void structures might have been expelled or compressed under high pressure and filled with the pressure driven external impregnation medium. Hironaka et al., (2011) observed that impregnation in whole potatoes occurs mainly at the central medulla and the areas between the vascular ring and periderm since the medulla tissue is more permeable than the surrounding denser perimedullary starch storage parenchyma tissue.

The changes in total mass with temperature/pressure and time might have been the result of the balance between the pressure-driven mass gain and the mass loss due to water release and leaching of solids, such as starch granules, into the external medium. Leaching might have occurred because of cellular disruption at the sample surface at the time of cutting and because of changes in the cellular tissue subjected to hydrostatic pressures.

Sweet potatoes had an average moisture content of 80.98±0.93% and a soluble solids content of 11.4±0.2 g/100 g. Isochoric impregnation increased the moisture content by 2%, but had little influence on the soluble solids content. Table 1 shows the total mass changes, total volume changes, water contents and soluble solids contents of the apple and sweet potato samples.

The porosity of apples was 25.6±2.1%, which was similar to the porosity values reported in literature for Granny Smith apples. The control immersed apple sample showed a gradual increase in mass with time due to the infusion of the external solution into the apples by capillary action. In comparison, the isochoric impregnated apples showed a greater mass increase than the control samples due to the increase in mass transfer rates during pressure-induced impregnation. The mass transfer in the samples was due to osmosis, diffusion and hydrodynamic mechanisms. The impregnation temperature/pressure affected total mass changes in the samples.

A gradual increase in mass occurred with time at −3° C. (i.e lower pressure applied). In comparison, mass gain was highest after 3 hours of impregnation time at −5° C. (i.e higher sure applied). After h point, the apples lost mass, which might indicate a disruption of the parenchyma cellular tissue.

The control apple sample showed a volume increase that ranged from 1.8% to 2.4%, whereas the isochoric impregnated apples showed slightly higher increases in volume that ranged from 2.4% to 4.7%. The increase in volume could be due to the increase in cell turgor and swelling of the cellular components as water penetrated and diffused inside the cellular tissue. Fresh apples had a water content of 87.33%±0.09. The control samples had a slightly higher (<1%) water content, whereas isochoric impregnated samples had an average of 2.1% increase in water content. This was due to the concentration gradient, which favored mass transfer of water from the liquid medium to the product. The soluble solids content for fresh apples was 12.8±0.6 g/100 g. No significant differences (P>0.05) in the soluble solids content were found between fresh and treated apples.

The porosity of sweet potatoes was 9.6±2.6%, which was between the 15% porosity value reported by Lozano, Rotstein and Urbicain (1983), and the 4.3±2.1% porosity value reported by Monteiro et al., (2020). Sweet potatoes have very small intercellular spaces, but the potato tissue contains a vascular ring, numerous strands of embedded vascular tissue in the perimedullar storage parenchyma and large vascular strands in the inner medulla that could also contribute to the overall porosity value.

The control immersed potato samples showed a gradual mass increase from 0.5% after 1 hour to 1.6% after 5 hours due to capillary action. In comparison, isochoric impregnated samples gained an average of 9.3% mass. During isochoric impregnation, the gas phase present in the intercellular spaces and void structures might have been expelled or compressed under high pressure and filled with the pressure driven external impregnation medium. Hironaka et al., (2011) observed that impregnation in whole potatoes occurs mainly at the central medulla and the areas between the vascular ring and periderm since the medulla tissue is more permeable than the surrounding denser perimedullary starch storage parenchyma tissue.

The changes in total mass with temperature/pressure and time might have been the result of the balance between the pressure-driven mass gain and the mass loss due to water release and leaching of solids, such as starch granules, into the external medium. Leaching might have occurred because of cellular disruption at the sample surface at the time of cutting and because of changes in the cellular tissue subjected to hydrostatic pressures. Sweet potatoes had an average moisture content of 80.98±0.93% and a soluble solids content of 11.4±0.2 g/100 g. Isochoric impregnation increased the moisture content by 2%, but had little influence on the soluble solids content.

TABLE 1
Total mass change (ΔM), total volume change (ΔV), water
content (Xw) and soluble solid content (°Brix) of infused
apples and sweet potatoes with 4% ascorbic acid sucrose solution.

| | | Time | | | | |
|---|---|---|---|---|---|---|
| | Sample | (hr.) | ΔM (%) | ΔV (%) | Xw (%) | °Brix |
| Apple | Fresh | — | — | — | 87.33 ± 0.09^{c} | 12.8 ± 0.6^{a} |
| | Control | 1 | 0.26 ± 0.22^{d} | 2.1 ± 1.6^{b} | 87.85 ± 0.15^{de} | 12.6 ± 0.4^{a} |
| | Immersion | 3 | 0.87 ± 0.40^{d} | 1.8 ± 1.4^{b} | 88.10 ± 0.12^{d} | 13.0 ± 0.2^{a} |
| | | 5 | 1.89 ± 0.53^{c} | 2.4 ± 1.1^{b} | 88.08 ± 0.03^{d} | 12.2 ± 0.2^{a} |
| | Isoch. - | 1 | 19.56 ± 3.84^{b} | 2.7 ± 2.0^{ab} | 89.89 ± 0.11^{a} | 11.6 ± 0.2^{a} |
| | 3° C. | 3 | 20.94 ± 4.49^{ab} | 2.4 ± 2.1^{ab} | 89.57 ± 0.12^{ab} | 12.5 ± 0.4^{a} |
| | | 5 | 26.32 ± 3.94^{a} | 4.1 ± 1.7^{a} | 88.80 ± 0.08^{c} | 12.7 ± 0.2^{a} |
| | Isoch. - | 1 | 18.10 ± 3.95^{b} | 3.7 ± 1.8^{ab} | 89.26 ± 0.05^{b} | 13.1 ± 0.7^{a} |
| | 5° C. | 3 | 23.36 ± 3.74^{ab} | 2.6 ± 2.3^{ab} | 89.34 ± 0.07^{b} | 12.4 ± 0.3^{a} |
| | | 5 | 20.35 ± 1.97^{b} | 4.7 ± 1.8^{a} | 88.26 ± 0.04^{d} | 12.5 ± 0.4^{a} |
| Sweet | Fresh | — | — | — | 80.98 ± 0.93^{b} | 11.4 ± 0.2^{a} |
| Potato | Control | 1 | 0.54 ± 0.41^{b} | 2.2 ± 1.0^{b} | 81.53 ± 0.03^{b} | 11.3 ± 0.2^{a} |
| | Immersion | 3 | 1.07 ± 0.62^{ab} | 1.8 ± 1.2^{b} | 81.25 ± 0.23^{b} | 11.4 ± 0.4^{a} |
| | | 5 | 1.58 ± 0.14^{a} | 2.5 ± 2.4^{b} | 80.61 ± 0.10^{b} | 11.5 ± 0.3^{a} |
| | Isoch. - | 1 | 10.28 ± 1.37^{a} | 4.9 ± 2.0^{a} | 82.52 ± 0.38^{ab} | 11.5 ± 0.2^{a} |
| | 3° C. | 3 | 8.99 ± 0.51^{a} | 4.8 ± 2.0^{a} | 82.65 ± 0.10^{ab} | 11.6 ± 0.5^{a} |
| | | 5 | 9.88 ± 0.80^{a} | 5.3 ± 2.4^{a} | 82.96 ± 0.23^{ab} | 11.0 ± 0.4^{a} |
| | Isoch. - | 1 | 9.08 ± 2.03^{a} | 3.8 ± 3.0^{ab} | 83.38 ± 0.25^{a} | 11.3 ± 0.3^{a} |
| | 5° C. | 3 | 8.10 ± 0.42^{a} | 5.8 ± 1.6^{a} | 83.35 ± 0.24^{a} | 11.7 ± 0.2^{a} |
| | | 5 | 9.21 ± 1.09^{a} | 4.5 ± 2.1^{a} | 82.75 ± 0.51^{ab} | 11.7 ± 0.7^{a} |

Values are the means ± SD (n = 10 for ΔM and ΔV; n = 3 for Xw and Brix). Different letters in the same column for a specific commodity indicate significant differences at 0.05 probability.

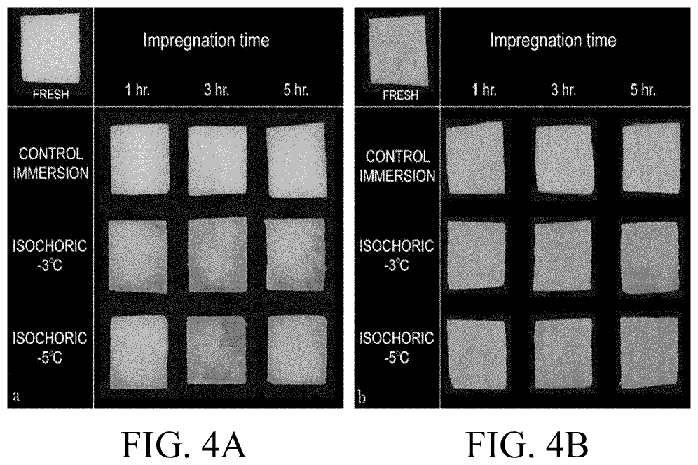

Representative color images (RGB scale) of half sliced samples are shown in FIG. 4a and FIG. 4b for apples and sweet potatoes, respectively. The color data is reported in Table 2. For apples, the color in the core of the control immersed samples was similar to the color of the fresh samples. The color difference with respect to the fresh apples (ΔE*) was lower than 5, which indicated that the changes in color were not visually perceived. However, FIG. 4a shows some darkening at the sample surface, verifying the infusion of the external solution towards the geometrical center of the samples by capillary action. Isochoric impregnated samples had an average color difference value of 13.4±3.3, which indicated that the color change was noticeable by an average consumer.

The impregnation treatment did not cause significant changes in the a* (red-green) and b* (yellow-blue) values, indicating the color difference was due to the reduction in the L* parameter and the corresponding darkening. Neri et al. (2016) and Fito and Chiralt (2000) also found this darkening behavior in vacuum impregnated samples, which was due to the decrease in the vegetable matrix reflectivity from the total or partial replacement of air by the impregnation solution. This effect also caused an increase in the translucency of the samples, as shown in FIG. 4a. The decrease in L* value was similar for all the isochoric impregnated samples independent of the impregnation processing conditions.

FIG. 4a also revealed that not all the available volume of the porous phase was occupied by the impregnation solution. Similar results have been found for other impregnated food matrices, such as mangos, kiwis, pears and strawberries. Apple tissue contains about 26% occluded gas by volume in the intercellular void space. Hydrostatic pressures during isochoric impregnation might have compressed or expelled the gas phase in some of the intercellular spaces, causing partial or total gas replacement by the external solution. However, some gas might have remained occluded in the void spaces since total porosity, shape, size, pore distribution and the connections between pores with the outer impregnation medium all might have influenced liquid uptake.

FIG. 4b shows a longitudinal slice of fresh sweet potatoes. The presence of opaque patches of cells indicated the presence of perimedullary starch-storage parenchyma and the intervening more translucent areas indicated a medullary zone containing internal phloem and phloem parenchyma strands. From Table 2, control immersed samples had similar color values to fresh samples. The color differences (ΔE*) for these samples were lower than 5. In comparison, isochoric impregnated samples had lower values of L*, a* and b* than the fresh and control samples, indicating the isochoric samples were darker, less reddish and less yellowish due to the infusion of the external solution into the samples. The different impregnation conditions used in the study had little effect on the colors of the impregnated samples.

TABLE 2
Color parameters of infused apple and sweet potato
with 4% ascorbic acid sucrose solution.

| | | Time | | | | |
|---|---|---|---|---|---|---|
| | Sample | (hr.) | L* | a* | b | ΔE* |
| Apple | Fresh | — | 70.9 ± 2.8^{a} | −2.14 ± 0.90^{ab} | 13.8 ± 4.5^{ab} | — |
| | Control | 1 | 73.8 ± 1.7^{a} | −2.55 ± 0.25^{b} | 15.3 ± 1.8^{a} | 3.9 ± 0.9^{c} |
| | Immersion | 3 | 73.2 ± 1.6^{a} | −2.06 ± 0.36^{ab} | 12.8 ± 2.6^{ab} | 3.3 ± 1.5^{c} |
| | | 5 | 71.1 ± 1.1^{a} | −2.79 ± 0.28^{b} | 15.5 ± 2.1^{a} | 2.4 ± 1.3^{c} |
| | Isoch. - | 1 | 55.7 ± 3.7^{bc} | −2.09 ± 0.22^{a} | 11.6 ± 1.6^{b} | 15.4 ± 3.9^{a} |
| | 3° C. | 3 | 53.5 ± 4.4^{c} | −1.88 ± 0.24^{a} | 9.1 ± 1.1^{b} | 18.1 ± 4.3^{a} |
| | | 5 | 58.6 ± 4.6^{bc} | −2.43 ± 0.63^{a} | 11.9 ± 3.5^{ab} | 12.8 ± 4.6^{ab} |
| | Isoch. - | 1 | 59.9 ± 0.9^{b} | −2.73 ± 0.18^{b} | 12.9 ± 1.1^{ab} | 11.1 ± 0.8^{b} |
| | 5° C. | 3 | 57.1 ± 1.9^{bc} | −2.03 ± 0.15^{a} | 9.8 ± 1.3^{b} | 14.4 ± 1.4^{a} |
| | | 5 | 62.3 ± 3.3^{b} | −2.72 ± 0.34^{b} | 14.3 ± 1.9^{ab} | 8.8 ± 3.0^{b} |
| Sweet | Fresh | — | 66.9 ± 0.4^{a} | 27.98 ± 0.77^{ab} | 32.3 ± 1.3^{a} | — |
| Potato | Control | 1 | 66.1 ± 1.2^{a} | 28.85 ± 1.10^{a} | 34.1 ± 1.6^{a} | 2.6 ± 0.4^{b} |
| | Immersion | 3 | 66.6 ± 0.8^{a} | 25.47 ± 1.19^{b} | 30.3 ± 1.0^{a} | 3.3 ± 1.6^{b} |
| | | 5 | 67.3 ± 1.2^{a} | 29.77 ± 0.52^{a} | 33.9 ± 1.4^{a} | 2.7 ± 0.6^{b} |
| | Isoch. - | 1 | 57.8 ± 1.5^{b} | 20.39 ± 1.79^{c} | 24.5 ± 1.7^{b} | 14.3 ± 1.8^{a} |
| | 3° C. | 3 | 58.4 ± 1.1^{b} | 25.71 ± 1.86^{b} | 28.5 ± 1.8^{b} | 9.8 ± 1.8^{a} |
| | | 5 | 56.3 ± 2.1^{b} | 23.90 ± 0.92^{b} | 27.1 ± 1.6^{b} | 12.6 ± 1.7^{a} |
| | Isoch. - | 1 | 57.7 ± 1.8^{b} | 20.91 ± 2.70^{bc} | 24.9 ± 2.8^{b} | 13.9 ± 3.5^{a} |
| | 5° C. | 3 | 55.8 ± 3.6^{b} | 22.74 ± 3.02^{c} | 26.2 ± 2.4^{b} | 13.9 ± 4.7^{a} |
| | | 5 | 55.3 ± 1.4^{b} | 23.47 ± 0.48^{b} | 28.0 ± 1.4^{b} | 13.3 ± 1.4^{a} |

Values are the means ±SD (n=6). Different letters in the same column for a specific commodity indicate significant differences at 0.05 probability

It is noteworthy to mention that browning did not occur in any of the apple or sweet potato samples. Ascorbic acid inhibits browning reactions, mainly because of its ability to scavenge oxygen and to reduce o-quinones to o-phenolic compounds before they can participate in further polymerization reactions that lead to the formation of irreversible brown pigments. Previous authors have reported the effectiveness of ascorbic acid for preventing browning in frozen foods. Blanda et al., (2008) observed a reduction in browning of apples impregnated with 1% ascorbic acid solution during frozen storage. Also, Zhao et al., (2021) observed that thawed potato samples frozen under isochoric conditions retained their color when the samples were immersed in 5% ascorbic acid solution.

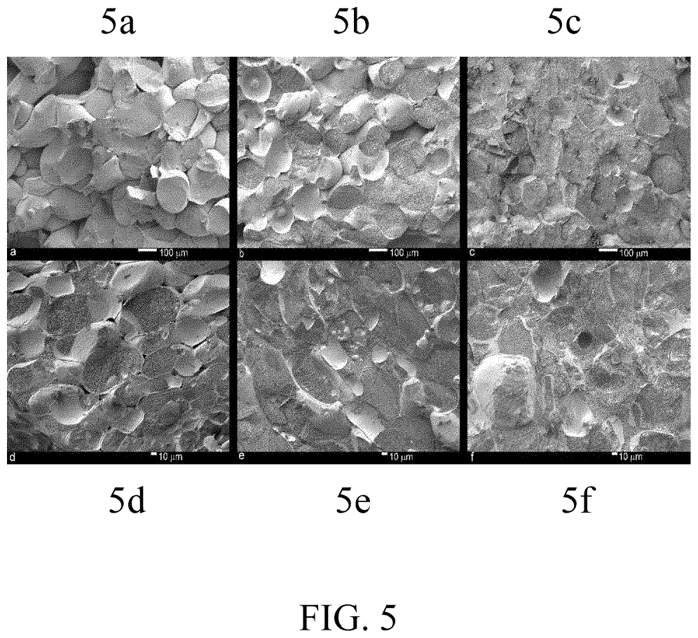

Cryo-SEM images were taken to visualize the effects of the isochoric impregnation temperature/pressure on the cellular tissue of apple and sweet potatoes impregnated for 5 hours. Fresh apple tissue (FIG. 5a) showed an organized cell distribution where cells and intercellular spaces were clearly differentiated. The intracellular content showed a dendritic structure that indicated the presence of water and solutes, whereas the intercellular spaces were completely empty.

Isochoric impregnated apples at −3° C. (FIG. 5b) showed flooded intercellular spaces with similar dendritic appearance to the intracellular volume, as well as empty intercellular spaces. These samples showed no apparent disturbances in the cellular tissue in terms of cell size, cell shape, cell-to-cell contact and intracellular appearance. In comparison, the cellular tissue of the isochoric impregnated apples at −5° C. (FIG. 5c) showed an increase in structural disorder with increased cell separation, indicating that pressure beyond a certain value (>21 MPa) led to significant changes in the apple tissue structure.

Sweet potato tissue contains a complex system of cells with small amounts of embedded starch granules (FIG. 5d). The cell sizes and shapes differed in different zones. The perimedullar parenchyma cells are bigger than the medullar cells. The potato cells showed higher degrees of cell-to-cell contact than apple cells, with few small intercellular spaces. The micrographs of the isochoric impregnated potato at −3° C. (FIG. 5e) were similar to the fresh samples, with no visible changes in the structures of the tissue. However, isochoric impregnation at −5° C. (FIG. 5f) caused an increase in the structural disorder and deformation of the cells, which indicated that pressures beyond 21 MPa could compromise tissue integrity.

With regard to texture, for apples, the control immersed samples had similar texture values to fresh samples. The isochoric impregnated samples had similar rupture stress and strain values to fresh samples but were between 4.5% and 16.4% more elastic. This loss in stiffness might be due to the replacement of intercellular gas by the external liquid solution that plasticized cell wall components and caused greater elasticity.

F potatoes, the control immersed samples and impregnated samples at −3° C. had similar texture values to fresh samples. However, isochoric impregnation for 3 hours at −5° C. decreased rupture stress and rupture strain by 25% and 16%, respectively, with no further changes at longer impregnation times. Abalos et al., (2020) reported that the exchange of gas by aqueous solution in impregnated sweet potatoes caused an increase in potato firmness. Therefore, the decrease in rupture stress in this study was most probably due to cell disruption caused by long exposure to hydrostatic pressures during the impregnation treatment as previously observed in, the microstructural analysis (FIG. 4f).

Raw Granny Smith apples had 3.12±0.30 mg/100 g ascorbic acid, which was similar to those reported by Mditshwa et al., (2015), who found vitamin C levels between 2.27 and 3.46 mg/100 g. For apples, the control immersed samples showed an increase in ascorbic acid content with an increase in impregnation time with values up to 362±18 mg/100 g after 5 hours. Isochoric impregnated samples showed higher ascorbic acid contents than the control samples. The isochoric samples impregnated at −3° C. had an ascorbic acid content of 446±30 mg/100 g after one hour with the content increasing to 517±23 mg/100 g at longer processing times. The isochoric samples impregnated at −5° C. had a maximum ascorbic acid content after 3 hours (501±35 mg/100 g) with longer impregnation times causing lower ascorbic acid gain (467±31 mg/100 g). These results were consistent with the total mass gains observed for these samples (Table 1).

Raw sweet potatoes had higher ascorbic acid content than apples with a value of 12.1±2.9 mg/100 g. For control immersed samples, ascorbic acid content increased up to 241±12 mg/100 g after 5 hours, whereas the isochoric impregnation process increased ascorbic acid contents up to between 322 and 393 mg/100 g, depending on the impregnation conditions. Sapers et al., (1990) also observed that ascorbic acid content of potato cylinders immersed in ascorbic acid solution increased significantly by pressure infiltration, compared to dipping at atmospheric pressure. Processing time did not significantly affect ascorbic acid content. However, the samples impregnated at −5° C. (i.e. higher pressure applied) showed 14% higher increase in ascorbic acid content than the samples impregnated at −3° C. (i.e. lower pressure applied). These results indicated that the highest pressure of 42 IN/1-Pa increased ascorbic acid content due to a more complete filling of the intercellular spaces and void vascular system with the external solution and possible changes in the permeability of the cell membranes and/or tissue structure_Sopanangkul, Ledward, and Niranjan, (2002) observed that pressure increases from 0.1 MPa to 600 MPa resulted in potato cells that appeared to be progressively more permeabilized and a tissue architecture that opened up to diffusion. The increase in cell permeabilization with pressure has been reported to be due to a phase transition in the phospholipid bilayers from liquid crystalline to a gel phase. The coexistence of the gel and liquid crystalline phases resulted in poorer packing of the acyl chains and an increase in cell membrane permeability.

### Conclusion

The inventors investigated isochoric impregnation of apples and sweet potatoes with a bioactive compound (ascorbic acid). Apple and potato cylinders were impregnated with a sucrose solution containing 4% ascorbic acid (ascorbic acid) while freezing under isochoric conditions. Isochoric impregnation resulted in greater infusion of ascorbic acid compared to infusion at atmospheric pressure, which demonstrated the feasibility of this impregnation technology. Processing temperatures (−3° C. and −5° C.) and processing times (1, 3 and 5 hours) significantly affected the ascorbic acid infusion. The ascorbic acid content values ranged from 446 to 516 mg/100 g for apples and 322 to 831 mg/100 g for sweet potatoes under isochoric conditions, whereas the maximum ascorbic acid contents for infused apples and sweet potatoes at atmospheric pressures were 18 mg/100 g and 241 mg/100 g, respectively. For both plant materials, isochoric impregnation at −3° C. did not cause major changes in texture and microstructure of the biological tissues. These results indicated that isochoric impregnation of solid foods could be a feasible technology for infusion of bioactive compounds without significantly altering its matrix. The isochoric impregnated apples and sweet potatoes had similar textures to fresh samples since the cellular tissues were well preserved. Also, isochoric impregnation preserved samples from browning, but samples appeared translucent due to the infusion of the sucrose/ascorbic acid solution into the pores of the cellular tissue.

Isochoric impregnation can be an effective, efficient, and beneficial processing technique in the production of final packaged foods. The simultaneous quality preservation due to the absence of ice crystals inside the foods along with food fortification during storage under isochoric freezing conditions are very adventitious in developing functional foods to meet market demands.

### Experiment Group 3—Post Harvest Sweet Cherries

This series of experiments investigated the effects of isochoric cold storage with (and without) isochoric impregnation with a sucrose/ascorbic acid solution, on the physicochemical, nutritional, and microbiological qualities of post-harvest sweet cherries. Sweet cherries have a high commercial value and a short harvest season. Sweet cherries also have a high respiratory rate and are vulnerable to physiological disorders such as bruising and pitting. Sweet cherries are also susceptible to fungal rots. The high value, short harvest season and storage vulnerabilities of sweet cherries make sweet cherries a good candidate for the exploration of enhanced storage processes—like isochoric impregnation.

Specifically, sweet cherry fruits (Prunus avium L., cultivar ‘Bing’), were obtained from a Commercial Agricultural Cooperative in Berkeley (California, US). Fruit with stalks and without defects of uniform color and weight (10.0-12.5 g) were selected.

The isochoric system consisted of an OC-9 pressure chamber made of grade 316 stainless steel from High Pressure Equipment Company (Erie, Pa., USA). The inner diameter of the pressure chamber was 5.08 cm, the outer diameter was 11.11 cm and the inside depth was 25.4 cm. The total volume capacity was 500 mL. A screw and metal seal was used to close the chamber. During the experiments, the chamber was connected to an electronic pressure transducer that was connected to a laptop to monitor the pressure. The data was recorded and displayed with the Additel 9502 data logging and graphical software. The system was cooled using a recirculating bath filled with a water and ethylene glycol (50:50) solution.

Three different methods were used to preserve cherry fruits for 30 days: refrigeration at 3° C./90% RH, isochoric cold storage at −5° C./15 MPa and isobaric cold storage at −5° C./0.1 MPa. The processing temperature of −5° C. was chosen based on preliminary work of the inventors.

For the isochoric treatment, two different procedures were used. In the first procedure, the cherries were vacuum-packed in moisture-impermeable plastic bags using the FoodSaver vacuum sealer. A single packet containing 6 cherries was placed at the top of the chamber. An ice nucleating piece (screw) was placed at the bottom of the isochoric chamber to ensure that ice formed far from the cherry packet. The chamber was filled with water: food grade polyethylene glycol (95:5) solution. In the second procedure, six cherries were directly placed inside the chamber filled with an impregnation solution at a ratio of about 6.5/1 of solution mass to fruit mass. The impregnation medium consisted of an isotonic solution of 17% sucrose (S) and 1% ascorbic acid in distilled water. The isochoric treatments were run in duplicate with a total of 12 cherries per treatment. After the treatments, the cherries were slowly thawed at 5° C. for 14 h and then equilibrated to 22° C. before analysis.

For the isobaric treatment, two similar procedures to the isochoric treatment were used. The cherries were vacuum packed or packed by immersion in the impregnation solution at a ratio 6.5/1 of solution mass to fruit mass. Then the packets were immersed in the recirculating bath.

For each treatment, the mass of all twelve cherries was individually measured before and after treatment. Mass change was calculated and reported as the percent change in sample mass based on its initial mass. The moisture content was determined in triplicate using a conventional oven at 105° C. for 72 h. The soluble solids content (expressed as ° Brix) was determined in triplicate by measuring the refractive index of the juice with a digital refractometer.

Skin color was measured on the cheek area of 6 cherry fruits using a tristimulus colorimeter with a 8 mm diameter CM-A196 Target Mask. Instrumental color was measured using Illuminant D65 and 10° observer angle. Color response variables were expressed according to the CIE Lab system (L*-lightness, a*-red/green and b*-yellow/blue). The chroma (C*), hue angle (h*) and color difference (ΔE*) were calculated according to the following equations:

$${C}^{*} = \sqrt{{a}^{* 2} + {b}^{* 2}} \qquad ( 1 )$$

$${h}^{*} = arctan \frac{{b}^{*}}{{a}^{*}} \times \frac{180}{π} ( degrees ) \qquad ( 2 )$$

$$Δ {E}^{*} = \sqrt{{( Δ {L}^{*} )}^{2} + {( Δ {a}^{*} )}^{2} + {( Δ {b}^{*} )}^{2}} \qquad ( 3 )$$

Mechanical tests were performed with a Texture Analyzer (Stable Microsystems Ltd., TA-XT2i, UK) at 23° C. on the same day after processing. A probe (3 mm diameter stainless steel cylinder) with a trigger force of 5 N penetrated the sample to a depth of 8 mm at a speed of 1 mm/s. It returned to its original height at a speed of 10 mm/s. Six cherries were measured for each treatment and each cherry was punctured twice, resulting in 12 measurements. Maximum stress was calculated as the peak compression stress during cherry penetration. The fracture strain was the strain at which the cherry failed via fracture. Modulus of elasticity (E) was obtained from the slope of the stress/strain curve in the elastic region. Radical scavenging capacity was determined using two methods: the DPPH radical scavenging activity according to Brand-Williams, Cuvelier, and Berset (1995) and the ABTS═⁺ radical cation decolorization assay according to Re et al. (1999). One gram of sweet cherry tissue with pits removed was homogenized in 20 mL of HPLC grade methanol in a 45 ml centrifuge tube. Tubes were capped, vortexed for 15 s and then stored at 4° C. overnight. The next day, the sample was vortexed for 15 s and then clarified by centrifugation (15,600 rpm, 15 min at 4° C.) using a SORVALL RC 5C Plus centrifuge. The supernatant was used to analyze for radical scavenging using DPPH- and ABTS═⁺ free radicals.

For the determination of DPPH radical scavenging activity, 50 μl of cherry extract reacted with 2950 μl of 2,2-diphenyl-1-picrylhydrazyl (DPPH, 103.2 μM in methanol) in a shaker at room temperature for 20 h. Absorbance at 515 nm was recorded using a Shimadzu PharmaSpec UV-1700 spectrophotometer (Shimadzu Scientific Instruments, Inc., Columbia, Md.). The antioxidant activity was calculated by measuring the decrease in the sample absorbance compared to a methanol sample and quantified from a standard curve developed for Trolox (0-750 μg/ml). Antioxidant (AOX) values were expressed as milligrams of trolox equivalent (TE) per gram.

For the ABTS═⁺ assay, the ABTS═⁺ solution was prepared by mixing 25 mL of 8 mM ABTS═⁺ salt with 25 mL of 3 mM potassium persulphate in water. The solution was held at room temperature in the dark for 16 h before use. The ABTS═⁺ solution was diluted with 95% ethanol to obtain an absorbance between 0.8 and 1.0 at 734 nm. Fresh ABTS═⁺ solution was prepared for each analysis. Twenty microliter of cherry extract or Trolox standard solution (0.1, 0.2, 0.3 and 0.4 microM) was mixed with 1 ml ABTS═⁺ solution and incubated for 30 mins at 30° C. The absorbance at 734 nm was measured using a Shimadzu PharmaSpec UV-1700 spectrophotometer. Ethanol (95%) was used as a blank. The free-radical-scavenging activity was expressed as micromoles of Trolox per gram of sample (micromol TE/g fw or dw).

For each treatment and control, microbial evaluations were conducted in triplicate using 3 cherries without seeds. Half the cherry was homogenized with peptone water (0.1%) using a stomacher for 90 s. Decimal dilutions were prepared for the enumeration of total mesophilic aerobic bacteria, yeast and molds. Microbial colonies were obtained by the pour plate method on plate count agar for mesophilic aerobic bacteria incubated at 30° C. for 48 h and on potato dextrose agar for yeast and molds incubated at 25° C. for 72 h. Microbial counts were conducted in duplicate and results were expressed as log CFU g-1.

The results were statistically analyzed using Minitab version 19 statistical software. Significance differences between different treatments were assessed by performing analysis of variance (ANOVA) and Interval plots at 95% confidence intervals. Statistically significant differences at the level of p≤0.05 were marked with different letters. The mass, ° Brix and water content of cherry samples before and after preservation are shown in Table 1. The highest value of weight loss was 27.6% for refrigerated cherries.

Weight loss in cherries during storage at refrigeration temperatures was mainly due to the water loss caused by transpiration and respiration processes. Sweet cherry fruit has a low skin diffusion resistance and high surface/volume ratio, which promotes rapid water loss. Refrigerated cherries also showed an increase in soluble solids content, which might be due to soluble solids concentration after water loss or breakdown of starch to sugar during storage. Isochoric cold storage minimized weight loss. The lowest value of mass loss was 7.1% for cherries stored under isochoric conditions and immersed in the sucrose/ascorbic acid solution. Also, water and soluble solids content for isochoric cherries did not change significantly during preservation time. In comparison, weight loss increased significantly for isobaric cold stored cherries. The cellular structure of the cherry was seriously damaged during isobaric storage (FIG. 3) due to ice formation, resulting in 18.5% and 16.2% weight loss for vacuum packed and sucrose/ascorbic acid samples, respectively.

TABLE 3
Effect of preservation on mass loss, water content and °Brix.

| | Mass loss | Water content | |
|---|---|---|---|
| Sample | (%) | (%) | Brix |
| Fresh | | 85.0 ± 1.6 ^{a} | 17.4 ± 1.8 ^{b} |
| Refrig. | −27.6 ± 3.6 ^{c} | 81.2 ± 1.0 ^{b} | 20.2 ± 0.7 ^{a} |
| Isoch. sucrose/ | −7.1 ± 3.0 ^{a} | 84.9 ± 1.0 ^{a} | 18.1 ± 0.8 ^{b} |
| ascorbic acid | | | |
| Isoch. VP | −9.3 ± 5.7 ^{ab} | 85.5 ± 0.6 ^{a} | 17.8 ± 0.5 ^{b} |
| Isob. sucrose/ | −16.2 ± 5.8 ^{ab} | 86.1 ± 1.2 ^{a} | 16.5 ± 0.7 ^{b} |
| ascorbic acid | | | |
| Isob. VP | −18.5 ± 5.8 ^{b} | 78.8 ± 1.7 ^{b} | 27.7 ± 0.7 ^{a} |

For each column, values followed by the same letter ^{(a-c)} were not statistically different at p < 0.05

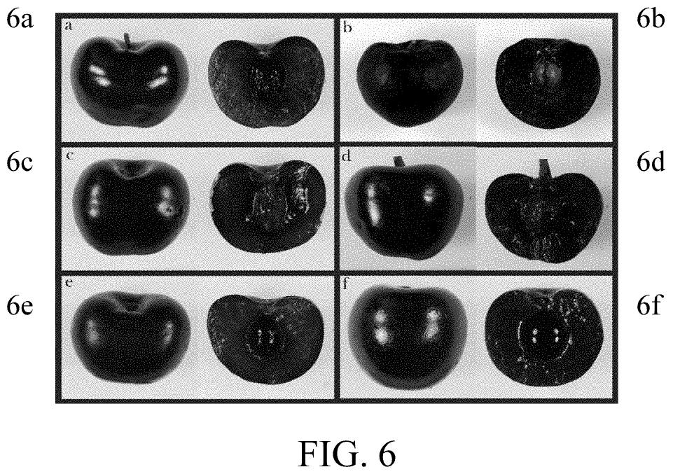

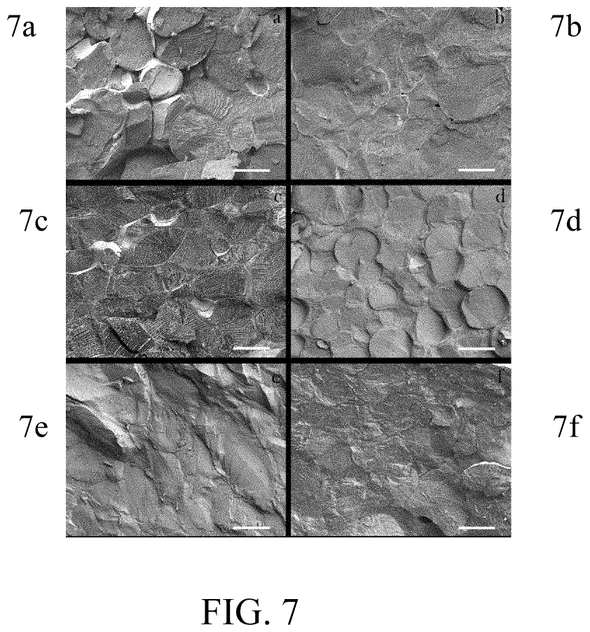

The appearance and color of the fresh and preserved Bing cherries are shown in FIG. 6 and Table 4. The L* (lightness), a* (redness), b* (yellowness) and C*(chroma) values decreased for all preserved cherries, reflecting the loss of the shiny red skin color, as shown in FIG. 1. The isochoric vacuum-packed samples appeared dark and blackish, indicating that the low storage temperature might have decreased the respiration rate. However, senescence still occurred, resulting in a decrease in the lightness and chroma of the cherries. The change in color with senescence had been attributed to degradation of anthocyanins and biochemical processes, such as loss of cell compartmentation that allowed enzymes to act on their substrates. Also, isobaric vacuum-packed cherries appeared dark and blackish due to enzymatic browning. The color of the cherries was better preserved when samples were immersed in the sucrose/ascorbic acid solution, as indicated by the higher chroma and hue angle values compared to vacuum-packed samples. However, some darkening still occurred in the samples. In the presence of oxygen, ascorbic acid can accelerate the degradation of anthocyanins and enhance the formation of polymer pigments, which resulted in anthocyanins pigment bleaching. However, the degradation reactions of anthocyanins with ascorbic acid might have been minimized by the limited presence of oxygen. Refrigerated cherries showed the highest loss in color due to ongoing senescence processes at the higher temperature of 3° C. and also appeared shriveled (FIG. 6). The anthocyanins bleaching effect due to the presence of ascorbic acid was more evident for refrigerated cherries immersed in sucrose ascorbic acid solution (sample not shown). These samples appeared whiter and showed even higher loss in color (ΔE*=9.5, h*=22.7) due to anthocyanin bleaching in the presence of ascorbic acid and oxygen.

TABLE 4
Effect of preservation technology on color parameters.

| Sample | L* | a* | b* | C* | h* | ΔE* |
|---|---|---|---|---|---|---|
| Fresh | 24.7 ± 0.5 ^{a} | 9.7 ± 1.2 ^{a} | 2.4 ± 0.4 ^{a} | 10.0 ± 1.2 ^{a} | 13.9 ± 1.2 ^{a} | — |
| Refrig. | 22.8 ± 2.1 ^{ab} | 3.4 ± 2.2 ^{b} | 0.6 ± 0.6 ^{c} | 3.5 ± 2.2 ^{bc} | 8.1 ± 4.6 ^{b} | 7.0 ± 2.5 ^{ab} |
| Isoch. sucrose/ | 22.4 ± 1.2 ^{b} | 5.5 ± 2.0 ^{b} | 1.2 ± 0.6 ^{bc} | 5.6 ± 2.1 ^{bc} | 11.0 ± 3.7 ^{ab} | 5.3 ± 1.6 ^{ab} |
| ascorbic acid | | | | | | |
| Isoch. VP | 23.3 ± 0.8 ^{b} | 3.2 ± 1.3 ^{b} | 0.4 ± 0.4 ^{c} | 3.3 ± 1.4 ^{c} | 6.4 ± 5.0 ^{b} | 6.9 ± 1.4 ^{a} |
| Isob. sucrose/ | 23.0 ± 1.0 ^{b} | 6.4 ± 1.2 ^{b} | 1.7 ± 0.4 ^{b} | 6.6 ± 1.2 ^{b} | 14.7 ± 0.5 ^{a} | 4.0 ± 1.0 ^{b} |
| ascorbic acid | | | | | | |
| Isob. VP | 22.8 ± 1.1 ^{b} | 4.6 ± 1.2 ^{b} | 1.2 ± 0.5 ^{bc} | 4.7 ± 1.2 ^{bc} | 13.8 ± 4.8 ^{ab} | 5.7 ± 1.5 ^{ab} |

For each column, values followed by the same letter (^{a-c}) were not statistically different at p < 0.05

Sweet cherry texture is an important quality attribute for consumer acceptance as well as for storability and shipping purposes. Puncture test results for fresh and preserved cherries are shown in Table 5. Maximum stress, fracture strain and elasticity modulus of fresh cherry fruit were 0.31±0.06 MPa, 0.59±0.06 and 0.67±0.23 MPa, respectively. Refrigerated cherries showed a significant increase in maximum stress due to an increase in hardness from loss of water. These cherries also became more rigid as indicated by an increase in the elastic modulus and showed greater fracture strains. Texture change during the ripening and storage of sweet cherry had been related to the respiration rate and the enzymatic degradation of the pectin-rich middle lamella of cell walls. Remon et al., (2003) found that the activity of pectinmethylesterase (PME) present in sweet cherries increased approximately 2-2.5-fold after 10 days of storage at 5° C., leading to breakdown of the cell wall and texture loss.

Cherries preserved under isochoric conditions had the best mechanical properties. These cherries had similar maximum stress values to fresh cherries, with slightly higher fracture strain and slightly lower elasticity modulus values. The low temperatures during isochoric cold storage might have reduced the respiration rate and the activity of the enzymes responsible for the degradation of the middle lamella. The cherries impregnated with sucrose/ascorbic acid solution had the most comparable texture to fresh cherries, though ANOVA results indicated no significant differences between vacuum packed cherries and cherries immersed in solution. In comparison, the maximum stress values of isobaric cold stored cherries were significantly lower than those of fresh cherries regardless of the isobaric procedure, indicating that ice formation during storage compromised the integrity of the cell membranes and walls. The elastic modulus also decreased significantly in value for these samples, indicating a more elastic behavior associated with a loss in cell turgidity. Furthermore, the cherries did not fracture during the compression tests since the cherries were not rigid enough to break or rupture.

TABLE 5
Effect of preservation technique on
mechanical properties of Bing cherry.

| | Maximum | | Elasticity |
|---|---|---|---|
| | Stress | Fracture | Modulus |
| Sample | (MPa) | Strain | (MPa) |
| Fresh | 0.31 ± 0.06 ^{b} | 0.59 ± 0.06 ^{b} | 0.67 ± 0.23 ^{ab} |
| Refrig. | 0.62 ± 0.08 ^{a} | 0.78 ± 0.08 ^{a} | 1.01 ± 0.25 ^{a} |
| Isoch. sucrose/ | 0.32 ± 0.06 ^{b} | 0.75 ± 0.07 ^{a} | 0.57 ± 0.14 ^{b} |
| ascorbic acid | | | |
| Isoch. VP | 0.28 ± 0.07 ^{bc} | 0.77 ± 0.08 ^{a} | 0.46 ± 0.17 ^{b} |
| Isob. sucrose/ | 0.16 ± 0.02 ^{c} | N/A | 0.15 ± 0.02 ^{c} |
| ascorbic acid | | | |
| Isob. VP | 0.26 ± 0.06 ^{c} | N/A | 0.20 ± 0.10 ^{c} |

For each column, values followed by the same letter ^{(a-c)} were not statistically different at p < 0.05

FIG. 6 shows the microstructure of the fresh and preserved cherry samples. FIG. 6a shows the cell structure of the fresh cherry sample. The cells appeared intact with well-defined cell walls and empty intercellular spaces. Refrigerated cherries showed deformed cell walls, cell shrinkage and absence of cell turgor associated with water loss (FIG. 6b). The isochoric frozen cherries (FIGS. 6c and 6d) had similar cell structures to that shown in fresh tissue cells. The cells appeared practically undeformed. However, the intercellular spaces showed a similar dendritic appearance as the intracellular volume, indicating the presence of water and solutes. For cherries impregnated with sucrose/ascorbic (FIG. 6c), the flooded intercellular spaces might be due to the sucrose and ascorbic acid introduced in the cherry pores, thereby confirming the effectiveness of the impregnation treatment. These results were consistent with the higher ascorbic acid content in this sample (Table 6). For vacuum-packed cherries (FIG. 6d), the fluid in the intercellular spaces might be due to leakage of water and cellular components from damaged cells. The difference in compressibilities between the cellular materials and empty intercellular spaces might be greater than those between cellular materials and intercellular spaces filled with the isotonic sucrose/ascorbic acid solution. This caused more cellular damage in vacuum-packed samples than in impregnated sucrose/ascorbic acid samples under pressure.

Isobaric frozen cherries showed a great degree of cell decompartmentation, as indicated by the poor definition of the cell walls and membranes observed in sucrose/ascorbic acid (FIG. 6e) and vacuum-packed cherries (FIG. 6f). Ice formation during freezing might have caused cell dehydration, leading to osmotic damages. In addition, some ice crystals may have punctured the cell membranes, causing additional mechanical damage.

Sweet cherry is considered a healthy fruit due to its bioactive compounds, such as anthocyanins and ascorbic acid, and its high antioxidant activity. Anthocyanin content, ascorbic acid content and antioxidant activity of fresh and preserved cherries are shown in Table 4. Fresh cherry had an anthocyanin content of 26.4±1.8 mg/100 g. Similar values were found by Gonsalves et al. (2004). All preserved cherries showed a decrease in anthocyanin content. Refrigerated samples had the highest anthocyanin content after 30 days of storage (83% of the initial anthocyanin concentration) followed by isochoric samples with sucrose/ascorbic acid impregnation (74% of the initial anthocyanin concentration). Esti et al (2001) also found that the total anthocyanins content decreased to about half its value during cold storage for 15 days at 1° C. At refrigerated temperatures, the anthocyanin decrease had been attributed to the high oxidative activity of polyphenoloxidase and increased pH. Isochoric stored samples showed higher anthocyanin content than isobaric stored samples. The absence of ice crystal formation inside the cellular tissue during isochoric storage helped to minimize the physical damage to tissues, thereby preserving the majority of the total anthocyanins. In comparison, anthocyanins might have leaked out of the isobaric stored cherries. Also, membrane damage from ice formation during storage might have increased enzyme substrate interactions. Table 6 also shows that samples immersed in sucrose/ascorbic acid solution maintained the anthocyanin content at higher levels compared with vacuum-packed cherries. Levy, Okun and Shpigelman (2019) demonstrated that the addition of ascorbic acid to purified anthocyanins resulted in significantly enhanced anthocyanin degradation. However, the absence of oxygen in the isochoric system might have prevented anthocyanin degradation by ascorbic acid.

The total ascorbic acid content of fresh Bing cherries was 17.4±2.4 mg/100 g of cherries (w.b.), which was similar to those found in other cherry cultivars at harvest. Ascorbic acid content in refrigerated cherries declined noticeably, as previously observed by other authors, due to enzymatic (via ascorbic acid oxidase) oxidation in the presence of oxygen. For cherries stored at subfreezing temperatures, vacuum-packed cherries better retained their ascorbic acid contents under isochoric conditions (89%) than under isobaric conditions (59%). Samples processed in the isotonic sucrose/ascorbic acid solution showed a marked increase in ascorbic acid content. For isobaric cherries, ascorbic acid from the external solution might have penetrated inside the cherries through the broken cellular tissue caused by ice formation. For isochoric cherries, the increase in ascorbic acid content might be due to an increase in mass transfer in response to elevated pressures, leading to pressure-induced impregnated cherries. These results indicated that isochoric impregnation with ascorbic acid could improve the ascorbic acid content and nutritional quality of sweet cherry fruit. From the results, 100 g of isochoric impregnated cherries could provide about 120% of the recommended daily intake of ascorbic acid, since the recommended daily ascorbic acid dose is 90 mg/day. In comparison, the same amount of fresh cherries provided about 19% of the recommended daily intake of ascorbic acid. The effect of preservation technology on antioxidant activity is also shown in Table 6. Cherries preserved in sucrose/ascorbic acid solution had slightly higher DPPH radical scavenging activity and ABTS═⁺ activity than fresh sweet cherries and those packed in vacuum. The ANOVA analysis indicated that these differences among treatments were significant for ABTS═⁺ results but not for DPPH radical scavenging activity results.

TABLE 6
Effect of preservation on anthocyanins content, ascorbic
acid content and antioxidant activity of cherries.

| | Anthocyanins | Ascorbic Ac. | DPPH | ABTS•⁺ |
|---|---|---|---|---|
| Sample | (mg/100 g) | (mg/100 g) | (mg TE/g) | (mg TE/g) |
| Fresh | 26.40 ± 1.81 ^{a} | 17.4 ± 2.4 ^{b} | 2.97 ± 1.20 ^{a} | 2.90 ± 0.71 ^{ab} |
| Refrig. | 22.00 ± 0.99 ^{ab} | 9.4 ± 1.03 ^{c} | 3.04 ± 0.71 ^{a} | 3.10 ± 0.85 ^{ab} |
| Isoch. sucrose/ | 19.58 ± 1.93 ^{b} | 110.8 ± 8.5 ^{a} | 3.54 ± 0.92 ^{a} | 4.90 ± 0.73 ^{a} |
| ascorbic acid | | | | |
| Isoch. VP | 14.70 ± 0.64 ^{c} | 15.5 ± 4.1 ^{bc} | 2.57 ± 0.60 ^{a} | 1.94 ± 0.40 ^{b} |
| Isob. sucrose/ | 16.53 ± 0.15 ^{c} | 128.3 ± 15.0 ^{a} | 3.45 ± 0.35 ^{a} | 5.90 ± 0.65 ^{a} |
| ascorbic acid | | | | |
| Isob. VP | 11.50 ± 0.12 ^{d} | 10.3 ± 3.0 ^{c} | 3.27 ± 0.47 ^{a} | 2.01 ± 0.49 ^{b} |

For each column, values followed by the same letter ^{(a-d)} were not statistically different at p < 0.05

The fresh cherries had no detectable counts of total mesophilic aerobic bacteria (TMAB) or yeast and mold. However, the refrigerated sample had a TMAB value of 2.81±1.15 log CFU/g and yeast and mold counts of 4.44±1.39 log CFU/g. Isochoric preservation inhibited mesophilic aerobic bacteria growth. However, the isochoric vacuum-packed cherries had yeast and mold counts of 2.68±0.58 CFU/g for, whereas the isochoric-sucrose/ascorbic acid cherries had no detectable yeast and mold. This was due to the antimicrobial effect of ascorbic acid, which had been previously reported in literature. The antimicrobial action of ascorbic acid had been attributed to the reduction of internal cellular pH, disruption of membrane transport and/or permeability and anion accumulation. Isobaric storage prevented bacterial, yeast and fungal growth in both vacuum-packed cherries and cherries immersed in sucrose/ascorbic acid solution.

### CONCLUSIONS

Cold storage under isochoric conditions at −5° C. effectively retarded the deterioration of cherry quality parameters and decay caused by bacterial and fungal growth. The subfreezing temperature during isochoric preservation decreases the respiration rate of sweet cherries, thereby slowing deteriorative metabolism and ultimately, delaying senescence. Also, the absence of ice crystals inside the cellular tissue reduced cell damage during storage.

The reduced deterioration of fresh cherries was enhanced by isochoric impregnation with a sucrose/ascorbic acid solution. Isochoric-sucrose/ascorbic acid cold storage better maintained the physicochemical properties of cherry fruit, including, weight, firmness, skin color and tissue integrity, compared with fruits stored at 3° C. and isobaric cold storage. Isochoric impregnation increased the ascorbic acid content of cherries by six times over that of fresh cherries, increasing their nutritional value. Furthermore, this treatment effectively controlled the growth of mesophilic aerobic microorganisms, yeasts and molds.

Essentially, Isochoric cold storage better preserved fruit quality for 30 days when compared with refrigeration and isobaric cold storage. Isochoric stored cherries impregnated with sucrose and ascorbic acid exhibited smaller weight loss (7.1%), lower browning, similar texture, higher anthocyanins retention (74%), 6 times higher ascorbic acid content and 19% higher antioxidant activity than fresh cherries. In addition, these cherries did not show microbial contamination (total mesophilic aerobic bacteria, yeasts and molds). The use of subfreezing temperatures during isochoric preservation helped to slow down quality deterioration due to senescence processes and microbial growth, while the absence of ice crystals inside the cellular tissue helped to preserve the integrity of the cherry fruits.

For the foregoing reasons, it is clear that the subject matter described herein provides an innovative means of infusing selected ascorbic acid impregnation fluids into fruits and vegetables. The current system may be modified in multiple ways and applied in various technological applications. For example, the current method and system can also be used to infuse various fluids into meats and other food and non-food items. The disclosed method and apparatus may be modified and customized as required by a specific operation or application, and the individual components may be modified and defined, as required, to achieve the desired result.

Although the materials of construction are not described, they may include a variety of compositions consistent with the function described herein. Such variations are not to be regarded as a departure from the spirit and scope of this disclosure, and all such modifications as would be obvious to one skilled in the art are intended to be included within the scope of the following claims.

The amounts, percentages and ranges disclosed in this specification are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all sub-ranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the implied term “about.” If the (stated or implied) term “about” precedes a numerically quantifiable measurement, that measurement is assumed to vary by as much as 10%. Essentially, as used herein, the term “about” refers to a quantity, level, value, or amount that varies by as much 10% to a reference quantity, level, value, or amount. Accordingly, unless otherwise indicated, the numerical properties set forth in the following specification and claims are approximations that may vary depending on the desired properties sought to be obtained in embodiments of the present invention.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein.

What is claimed is:

1. A method of infusing an ascorbic acid impregnation fluid into a targeted whole or cut fruit or vegetable, the method comprising the steps of:
(a) pouring an ascorbic acid impregnation fluid into a flexible food container;
(b) adding at least one targeted whole or cut fruit or vegetable to the food container so that the ascorbic acid impregnation fluid is in contact with the at least one fruit or vegetable;
(c) placing the food container in an isochoric chamber and filling the isochoric chamber with a water-based solution; and,
(d) reducing the temperature of the isochoric chamber to at least 0° C. so that ice forms in the isochoric chamber, wherein the ice formation causes pressure in the isochoric chamber to increase so that the ascorbic acid impregnation fluid penetrates the intercellular structure of the at least one fruit or vegetable, thereby infusing the at least one fruit or vegetable with the ascorbic acid impregnation fluid without destroying the cellular tissue of the fruit or vegetable.

2. The method of claim 1 wherein, in step (a), the ascorbic acid impregnation fluid also comprises is a sucrose.

3. The method of claim 1 wherein, in step (a), the ascorbic acid impregnation fluid is in the range of about a 0.1% to 4% by weight ascorbic solution.

4. The method of claim 3 wherein the ascorbic acid impregnation fluid further comprises sucrose in a range of about 5% to 25% by weight sucrose.

5. The method of claim 1 wherein, in step (a), the ascorbic acid impregnation fluid comprises about 4% ascorbic acid and about 7% sucrose in distilled water.

6. The method of claim 1 wherein, in step (d), the temperature is reduced to a range between about −2.0 and −6° C.

7. The method of claim 1 wherein, in step (d), the maximum pressure inside the isochoric chamber is less than or equal to about 30 MPa.

8. The method of claim 1 wherein, in step (d), the at least one fruit or vegetable is stored in the isochoric chamber at sub-freezing temperatures between for a time in the range of about 1 and 5 hours.

9. The method of claim 1 wherein infusion of ascorbic acid as described in step (d) results in a weight gain in the infused products, because ascorbic acid is retained in the at least one fruit and vegetable tissues.

10. The method of claim 1 wherein infusion of ascorbic acid as described in step (d) increases vitamin C in the at least one fruits or vegetables

11. The method of claim 1 wherein infusion of ascorbic acid as described in steps (a)-(e) prevents browning in the at least one fruits or vegetables.

12. The method of claim 1 wherein infusion of ascorbic acid as described in steps (a)-(e) prevents browning in the at least one fruits or vegetable products.

13. The method of claim 1 wherein infusion of ascorbic acid as described in steps (a)-(e) inhibits microbial growth.

14. The method of claim 1 wherein, in step (c), the water-based solution is distilled water, or a mixture of distilled water and food grade polyethylene glycol.

15. The method of claim 1 wherein, in step (b) the at least one fruit or vegetable is selected from a group consisting of apples, sweet potatoes, white potatoes, and sweet cherries.

16. The method of claim 1 wherein the at least one fruit or vegetable is a sweet cherry, and the method of claim further comprising:
(e) storing the sweet cherry in the isochoric chamber to extend its shelf-life for at least 30 days.

17. The method of claim 1 wherein the at least one fruit or vegetable is a sweet cherry, the isochoric impregnation process increasing the antioxidants by at least 10%.

18. At least one fruit or vegetable product created by the process described in claim 1.

19. A method of infusing a bioactive fluid into at least one fruit or vegetable to create a functional food product, the method comprising the steps of:
(a) pouring a bioactive impregnation fluid into a flexible food container;
(b) adding at least one targeted whole or cut fruit or vegetable to the food container so that the bioactive impregnation fluid is in contact with the at least one fruit or vegetable;
(c) placing the food container in an isochoric chamber and filling the isochoric chamber with a water-based solution; and,
(d) reducing the temperature of the isochoric chamber to at least 0° C. so that ice forms in the isochoric chamber, wherein the ice formation causes pressure in the isochoric chamber to increase so that the bioactive impregnation fluid penetrates the intercellular structure of the at least one fruit or vegetable, thereby infusing the at least one fruit or vegetable with the bioactive impregnation fluid without destroying the cellular tissue of the fruit or vegetable.

20. At least one fruit or vegetable product created by the process described in claim 19.
